(19) United States
(12) Patent Application Publication
(10) Pub. No.: US 2026/0101032 A1
(43) Pub. Date: Apr. 9, 2026

(54) CROSS-COMPONENT SAMPLE OFFSET EDGE DIRECTION DERIVATIONS

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Ting-Lan LIN, Palo Alto, CA (US); Shan LIU, Palo Alto, CA (US)

(21) Appl. No.: 19/352,316

(22) Filed: Oct. 7, 2025

Related U.S. Application Data
(60) Provisional application No. 63/704,366, filed on Oct. 7, 2024.

(51) Int. Cl. H04N 19/117; G06T 7/13; H04N 19/159; H04N 19/176; H04N 19/80

(52) U.S. Cl. CPC H04N 19/117; G06T 7/13; H04N 19/159; H04N 19/176; H04N 19/80

(57) ABSTRACT

An example method of video coding includes receiving a video bitstream comprising a plurality of frames, including a current frame comprising a current block. The method also includes determining an edge direction by performing edge detection for the current block, and determining a difference between a current sample of the current block and a neighboring sample based on the edge direction. The method further includes applying a filter to the current block based on the determined difference.

### RELATED APPLICATIONS

This application claims priority to U.S. Provisional Patent Application No. 63/704,366, entitled “CCSO Edge Direction Derivation,” filed Oct. 7, 2025, which is hereby incorporated by reference in its entirety.

### TECHNICAL FIELD

The disclosed embodiments relate generally to video coding, including but not limited to systems and methods for loop filtering (e.g., cross-component offset filtering) of video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to a coding/decoding process in which original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes methods, systems, and non-transitory computer-readable storage media for applying a loop filter for video (image) compression. A video codec includes a plurality of function modules for one or more of: intra/inter prediction, transform coding, quantization, entropy coding, and in-loop filtering. In-loop filtering technologies are applied to adjust reconstructed picture samples to further reduce a reconstruction error. Cross-component sample offset (CCSO) filtering may be implemented to apply a co-located reconstructed sample and associated neighboring reconstructed samples of a first color component to derive an offset value that is added on a current sample of a second color component, thereby adjusting a reconstruction value of the current sample. The CCSO filtering may use a signaled edge direction to identify reference samples for deriving the offset value.

As described herein, an edge direction (or corresponding filter index) for each block may be derived (at each of an encoder and decoder component) instead of signaled. For example, to reduce signaling overhead, the edge direction is not signaled but instead is derived using an edge detection method. The edge detection method may be the same method used for a Constrained Directional Enhancement Filter (CDEF). In addition to saving signaling overhead, the edge detection may be more accurate as it can be derived for each block rather than being signaled for an entire frame.

CCSO filtering is performed in accordance with a unit size and filter shape. As described herein, the unit size may be adaptively determined for each frame (rather than being a constant value). Adaptively selecting a unit size can improve the coding efficiency by making the filtering more accurate. As also described herein a filter shape index may be signaled in high-level syntax (e.g., at a frame level). The filter shape index may be overridden via lower level syntax. Selectively overriding the filter shape index can also improve coding efficiency by making the filtering more accurate.

In accordance with some embodiments, a method of video decoding includes: (i) receiving a video bitstream (e.g., a coded video sequence) comprising a plurality of frames (e.g., corresponding to a set of pictures), including a current frame comprising a current block; (ii) determining an edge direction by performing edge detection for the current block; (iii) determining a difference between a current sample of the current block and a neighboring sample based on the edge direction; and (iv) applying a filter to the current block based on the determined difference.

In accordance with some embodiments, a method of video encoding includes: (i) receiving video data (e.g., a source video sequence) comprising a plurality of frames, (e.g., corresponding to a set of pictures) including a current frame comprising a current block; (ii) determining an edge direction by performing edge detection for the current block; (iii) determining a difference between a current sample of the current block and a neighboring sample based on the edge direction; and (iv) applying a filter to the current block based on the determined difference.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and/or a decoder component.

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for coding video. Such methods, devices, and systems may complement or replace conventional methods, devices, and systems for video coding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments, and

FIG. 2B is a block diagram illustrating example elements of a decoder component in accordance with some embodiments.

FIG. 3 is a block diagram illustrating an example server system in accordance with some embodiments.

FIG. 4A illustrates the computation of a prediction block in accordance with some embodiments.

FIG. 4B illustrates the computation of a residue block in accordance with some embodiments.

FIG. 4C illustrates the computation of a reconstructed block in accordance with some embodiments.

FIG. 5A illustrates example in-loop filtering stages in accordance with some embodiments.

FIGS. 5B and 5C illustrate example filter shapes in accordance with some embodiments.

FIG. 5D illustrates example edge direction patterns in accordance with some embodiments.

FIG. 6A illustrates an example video decoding process in accordance with some embodiments.

FIG. 6B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a loop filter for video (image) compression. For example, an edge direction may be obtained by performing edge detection for the current block and then a difference between a current sample of the current block and a neighboring sample may be determined based on the edge direction. A filter to the current block may be applied based on the determined difference. Performing edge detection, as opposed to signaling/parsing an edge direction, saves signaling overhead and may result in a more accurate edge direction being used (e.g., because it is determined at a block level rather than being signaled at a frame level). As another example, for each frame of a plurality of frames, a respective unit size may be determined for a filter, then a filter may be applied to each frame using the respective unit sizes. In this way, the coding efficiency of the filter may be improved for each frame as compared to using a single preset unit size.

The present disclosure describes a set of methods for video coding that significantly enhance in-loop filtering, particularly through cross-component sample offset (CCSO) and constrained directional enhancement filter (CDEF) techniques. By deriving the edge direction for each block at both the encoder and decoder using one or more edge detection methods (e.g., such as CDEF edge detection, Canny, Sobel, or Laplacian of Gaussian operators, or intra prediction directions), the need for explicit signaling of edge direction at the frame level is eliminated, thereby reducing signaling overhead and enabling more accurate, block-specific filtering. The present disclosure further describes adaptive determination of the filtering unit size, e.g., aligning it with frame superblock sizes and supporting flexible block partitioning, which improves coding efficiency and filter accuracy. Additionally, the filter shape and index can be selectively overridden at the unit level, providing granular control that adapts to local content variations within a frame. As an example, a filter shape may be signaled in high-level syntax (e.g., a frame level) and then the filter shape may be overridden at a lower level (e.g., at a block level). Allowing the filter shape to be overridden improves coding efficiency by allowing a more accurate filter shape to be used for each block, as opposed to requiring the filter shape signaled in the high-level syntax to be used for all the blocks. Context-based signaling of filter parameters, considering factors such as color plane type and neighboring block properties, further optimizes compression. Collectively, these features result in reduced bitstream overhead, improved preservation of image details, enhanced coding efficiency, and superior adaptability to diverse video content, ultimately delivering higher video quality at lower bitrates.

### Example Systems and Devices

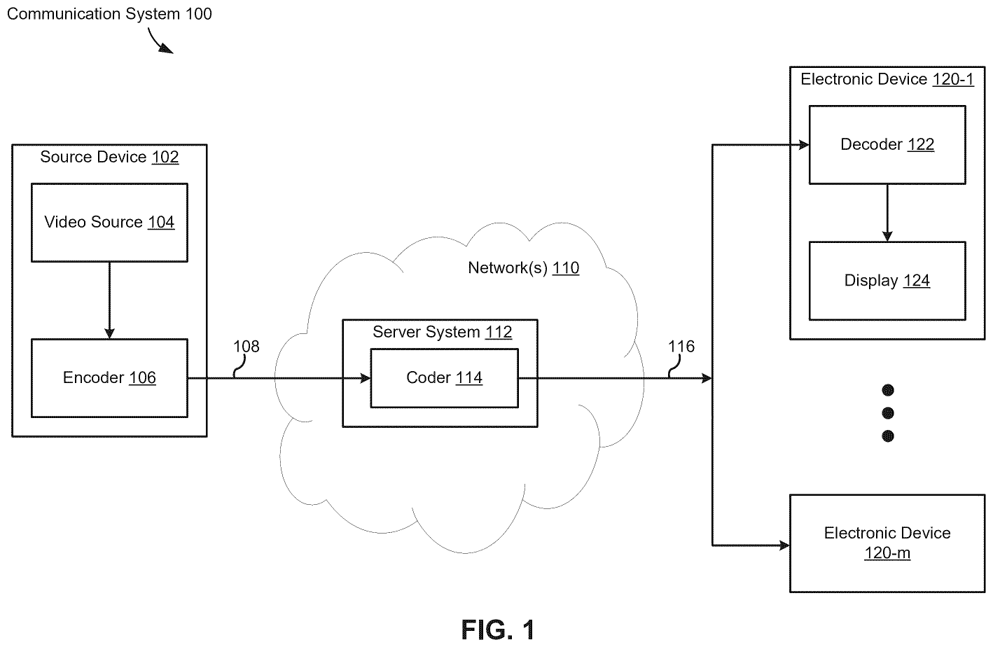

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

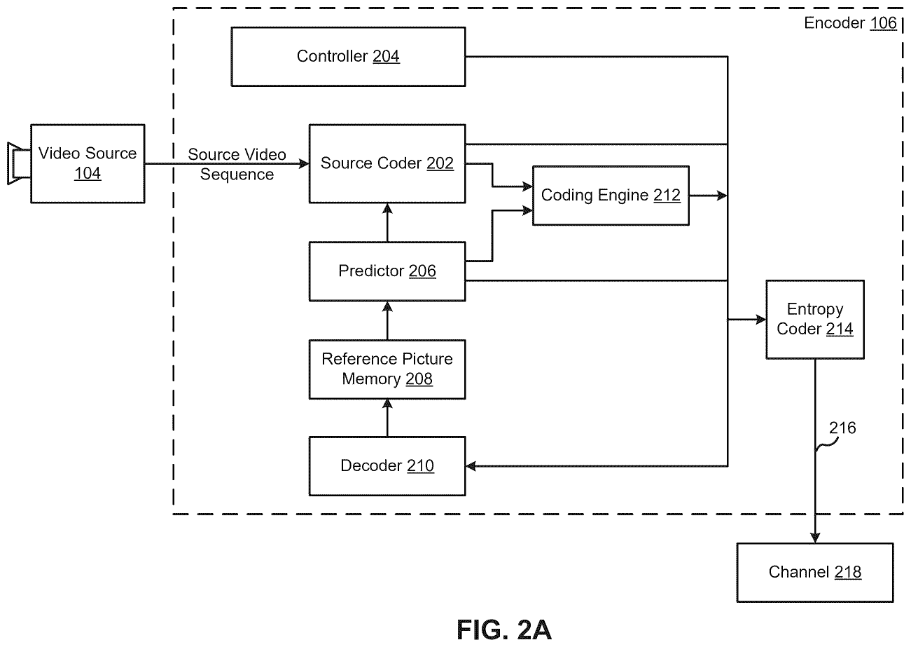

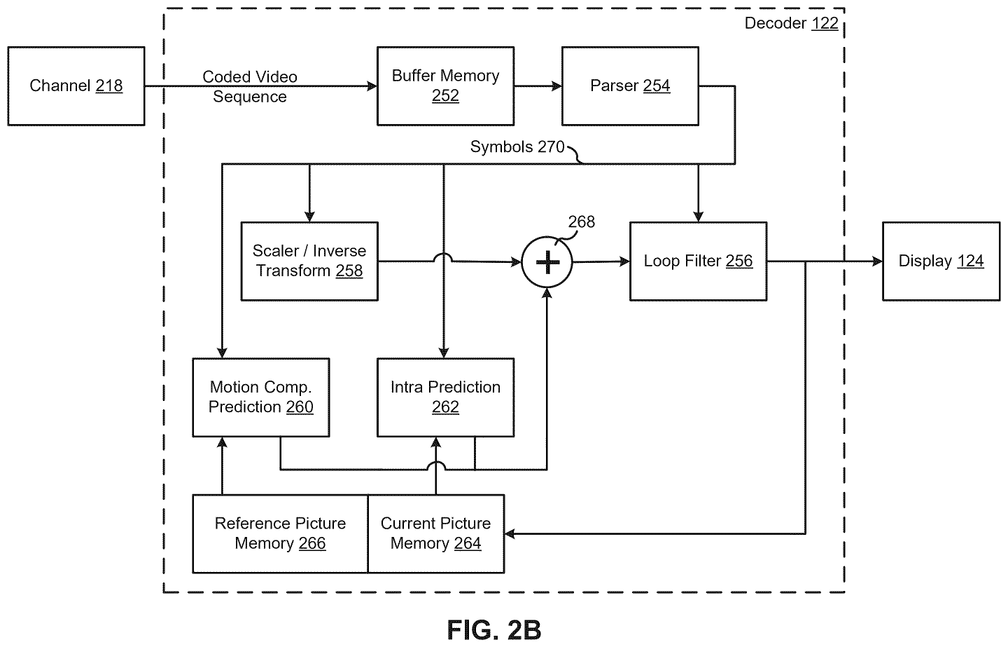

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

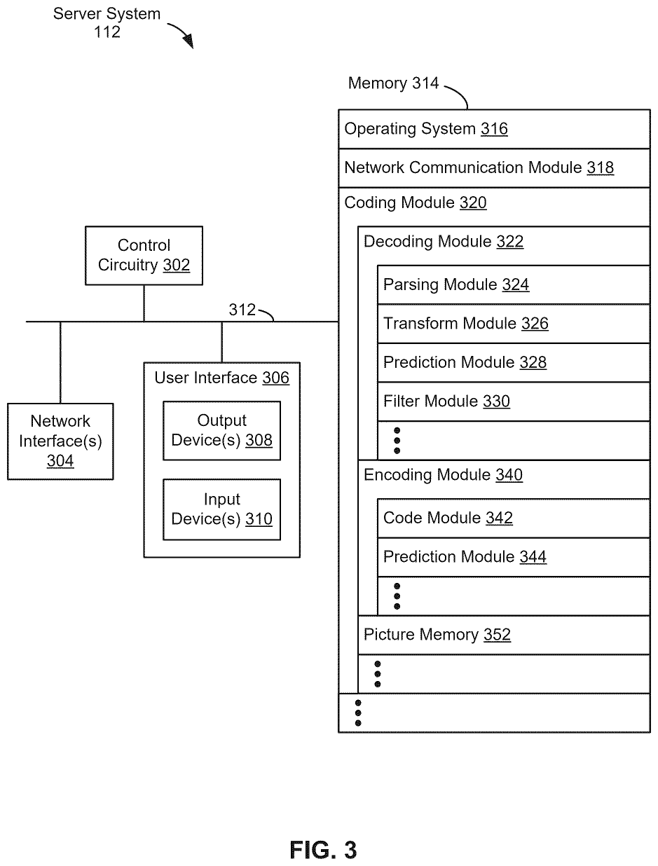

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for loop filtering (e.g., cross-component offset filtering) are described.

Digital video compression is a technology that enables efficient storage and transmission of video data across a wide range of devices and networks. Conventional video coding standards, such as H.264, H.265/HEVC, and H.266/VVC, employ various modules, including intra/inter prediction, transform coding, quantization, entropy coding, and in-loop filtering, to reduce data redundancy and achieve high compression efficiency. Among these, in-loop filtering contributes significantly to improving the quality of reconstructed video by reducing artifacts introduced during compression. Edge detection is a process in image and video processing that identifies the boundaries or transitions between different regions within an image, typically where there is a significant change in pixel intensity or color. In video coding, edge detection is crucial for distinguishing between smooth areas and areas with sharp transitions, such as object boundaries, which helps in applying filters more effectively and preserving important visual details.

For the Constrained Directional Enhancement Filter (CDEF), edge detection is performed on each block (e.g., an 8×8 block) using predefined directional patterns. The CDEF algorithm analyzes the pixel values along eight possible directions and selects the direction that minimizes the sum of squared differences between pixels and their mean along that direction. Once the dominant edge direction is determined, CDEF applies a non-linear filter along the detected direction (primary filter) and a secondary filter oriented at 45 degrees to the primary direction. This directional filtering reduces ringing and other artifacts while preserving sharp edges, resulting in improved visual quality of the reconstructed video.

Cross-Component Sample Offset (CCSO) is a filtering process using the co-located reconstructed sample and its neighboring reconstructed samples from a first color component as input, to derive an offset value that is added on the current sample of a second color component to adjust its reconstruction value. Examples of the first color component is luma color component, and examples of the second color component is chroma color component. The first color component and second color component can be the same color component, e.g., luma.

As described herein, in the context of CCSO filtering, edge detection is used to derive the filter index for each block, rather than signaling it explicitly in the bitstream. The edge direction for a block is determined using methods such as CDEF edge detection, Canny, Sobel, or Laplacian of Gaussian operators, or by referencing intra prediction directions. The detected edge direction is then mapped to a filter index using a predefined mapping table. This filter index guides the selection of neighboring samples and the computation of offset values, which are added to the current sample of a second color component (such as chroma) to adjust its reconstruction value. By deriving the edge direction locally for each block, CCSO filtering can more accurately preserve edges and reduce reconstruction errors, while also minimizing signaling overhead. Thus, edge detection enables both CDEF and CCSO filters to adapt their operations to the local structure of the video content, ensuring that filtering is applied in a way that preserves important details and improves overall coding efficiency.

In some embodiments a three-step process is used to derive offset values: (1) calculating delta values using co-located and neighboring reconstructed samples from a first color component, (2) quantizing the delta values into edge classes using scalar quantizers with configurable intervals, and (3) determining offset values based on the edge classes using specialized LUTs. By incorporating these steps, the described systems achieve improved coding efficiency and visual quality. Furthermore, the system architecture supports the concurrent operation of CCSO filtering with other in-loop filters, such as deblocking and constrained directional enhancement filters, to enhance the overall effectiveness of the video coding pipeline. This approach not only improves the reconstructed video quality but also ensures compatibility with existing video coding standards, making the solution adaptable and practical for modern video compression systems.

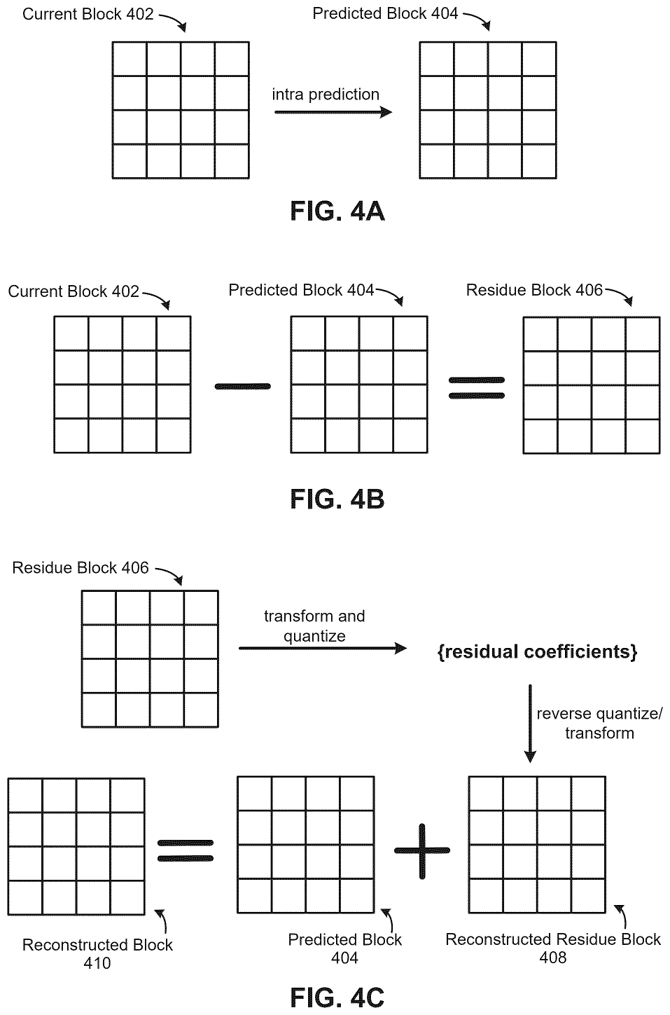

FIGS. 4A-4C illustrate an overview of a quantization and subsequent dequantization process. FIG. 4A illustrates the computation of a prediction block in accordance with some embodiments. In the example of FIG. 4A, an intra prediction is performed on a current block 402 to generate a predicted block 404. The current block 402 includes a set of samples (e.g., pixel blocks) and the prediction block 404 includes a set of predictions that correspond to the set of samples. FIG. 4B illustrates the computation of a residue block in accordance with some embodiments. As shown in FIG. 4B, the prediction block 404 is subtracted from the current block 402 to generate a residue block 406 that includes a set of residues. For example, respective differences are calculated between each sample and the corresponding prediction. FIG. 4C illustrates the computation of a reconstructed block in accordance with some embodiments. As shown in FIG. 4C, the residue block 406 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 408. The reconstructed residue block 408 is combined with the predicted block 404 (e.g., reconstructed residues of the reconstructed residue block 408 are added to predictions of the prediction block 404) to generate a reconstructed block 410 corresponding to the current block 402.

Notably, the transforms performed during decoding of the video bitstream may be inverses of the transformed performed during encoding of the video bitstream and are sometimes referred to as “inverse transforms”. For simplicity, the transformations described herein may be referred to as “transforms” whether performed during encoding or decoding.

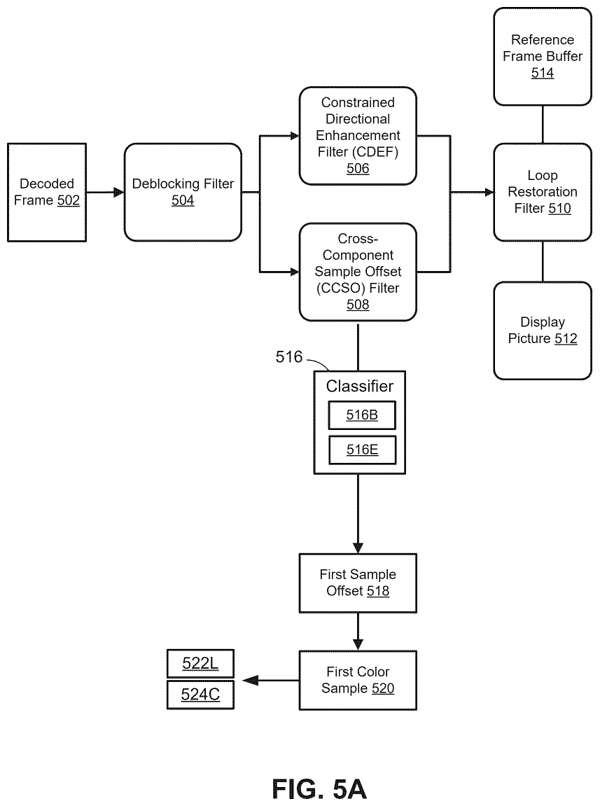

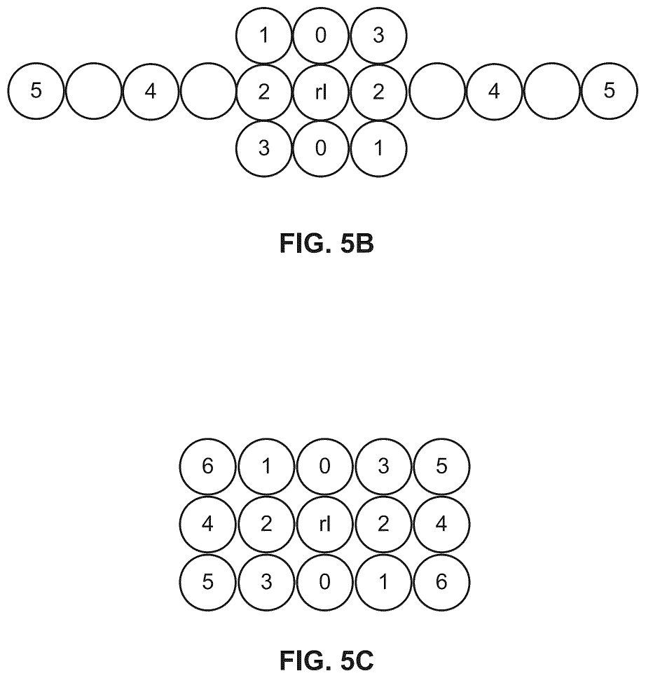

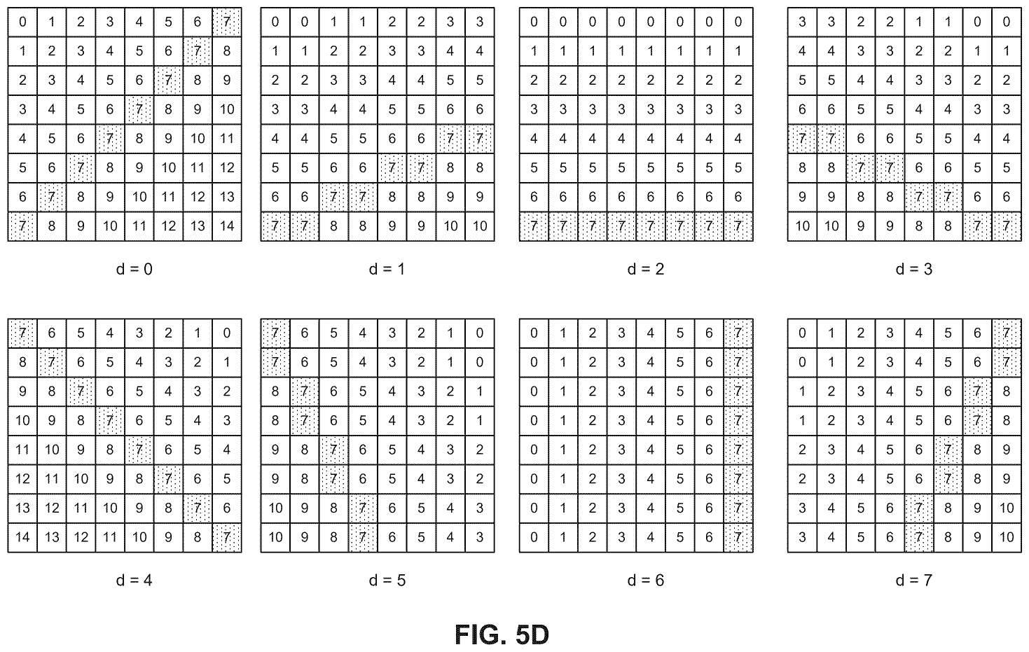

FIG. 5A illustrates example in-loop filtering stages in accordance with some embodiments. In the example of FIG. 5, the in-loop filtering stages applied to the decoded frame 502 include a deblocking filter 504, a CDEF 506, a CCSO filter 508 and a loop restoration filter 510. In some embodiments, the filtered output frame is used as a reference frame for later frames (e.g., stored in a reference frame buffer 514). In some embodiments, a normative film grain synthesis stage is also applied to generate a corresponding displayed picture 512. Unlike the in-loop filter stages, the results of the film grain synthesis stage (e.g., an out-of-loop filter) does not influence the prediction for subsequent frames. The loop filtering methods may include any filtering process applied on the reconstructed samples (e.g., after adding residual to the prediction), including wiener loop filtering, cross-component filtering via the CCSO filter 508 and the CDEF 506.

In some embodiments, a CCSO filtering method may use (e.g., by applying CCSO filter 508) a co-located reconstructed sample and neighboring reconstructed samples from a first color component as input, to perform filtering of the current reconstruction sample of a second color component. In some embodiments, a CCSO filtering method may use (e.g., by applying CCSO filter 508) the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter 508 may produce offset values, which are added to the reconstructed samples of the luma and chroma components to reduce reconstruction error. In some embodiments, the CCSO filter 508 operates concurrently with CDEF 506. For example, the reconstructed samples following deblocking 504 may be used as input for both the CDEF 506 and the CCSO filter 508.

The deblocking filter 504 may be applied across the transform block boundaries to remove block artifacts caused by the quantization error. In some embodiments, a filter length is determined based on the minimum transform block sizes on both sides. In some embodiments, finite impulse response (FIR) filters (e.g., low-pass filters) are used by the deblocking filter 504. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF 506 applies a non-linear de-ringing filter along particular (e.g., oblique) directions. The CDEF 506 may operate on an output of the deblocking filter 504. The CDEF 506 may operate in 8×8 units. In some embodiments, 8 preset directions are defined by rotating and reflecting templates of preset directions. The decoder may use the reconstructed pixels to select the prevalent direction index. A primary filter may be applied along the selected direction, and a secondary filter may be applied along an offset direction (e.g., oriented 45° off the primary direction). In some embodiments, up to 8 groups of filter parameters are signaled (e.g., in a frame header). The groups of filter parameters may include the primary and secondary filter strength indexes of luma and chroma components. The CDEF may apply filtering on reconstruction samples by identifying the direction of each block and then adaptively filtering with a high degree of control over the filter strength along the direction and across it.

In some embodiments, the loop restoration filter 510 is applied to reconstructed pixels after any prior in-loop filtering stages (e.g., the deblocking filter 504, the CDEF 506, and/or CCSO filter 508). The loop restoration filter 510 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

CCSO is designed for improved loop filtering on both luma and chroma components. In some embodiments, the filtering process of CCSO involves three main steps. First, the current reconstructed luma samples (e.g., the output of the deblocking process) are classified using classifiers 516. There are two types of classifiers: the edge-offset (EO) classifier 516E and the band-offset (BO) classifier 516B. These classifiers can operate jointly or individually based on indicators signaled at the frame level. Second, the class associated with the current luma sample is used as an index to fetch offset values from a lookup table (LUT), which is determined at the frame level with entries selected from a limited number of predefined values. This LUT is shared across the entire frame. Finally, the derived offset values using the LUT and class index are added to the corresponding luma and chroma components. A filter unit-level on/off flag (non-overlapped 256×256 luma samples) is signaled to indicate whether CCSO filtering is applied for the associated filter unit.

With continued reference to FIG. 5A, in some embodiments associated with band offset classification, the CCSO filtering method comprises a band offset classifier 516B. Based on the band offset classifier 516B, the decoder 122 may determine that a set of target luma samples includes a first luma sample and one or more neighboring luma samples. The set of target luma samples are provided to a quantizer, and used to generate one or more quantized values, which are further applied by the band offset classifier 516B to classify the first color sample 520. In some embodiments associated with edge offset classification, the CCSO filtering method comprises an edge offset classifier 516E. Based on the edge offset classifier 516E, the decoder 122 may determine that a set of target luma samples includes a first luma sample and one or more neighboring luma samples. Difference values of the neighboring luma samples and the first luma sample are provided to a quantizer, and used to generate one or more quantized values, which are further applied by the edge offset classifier 516E to classify the first color sample 520. In some embodiments, the first color sample 520 is classified, e.g., by the classifier 516, based on the quantized values to determine the first sample offset 518 of the first color sample 520. The first color sample 520 is adjusted based on the first sample offset 518 of the first color sample 520, thereby enabling reconstruction of the current image frame. In some embodiments, the first color sample 520 includes a first chroma sample 524C that is co-located with the first luma sample 522L in the current image frame, and the first chroma sample 524C is adjusted based on the first sample offset 518. Alternatively, in some embodiments, the first color sample 520 is the first luma sample 522L, and the first luma sample 524C is adjusted based on the first sample offset 518.

As described above, CCSO is an edge preserving loop filter that uses the reconstructed samples to compute the sample offsets of luma and/or chroma components. In some embodiments, only the luma samples located in positions defined by the filter shape are used to compute the offset of the chroma component or the luma component. In some embodiments, the offset value may be derived by three steps:
In the first step, values are derived using the co-located reconstructed sample and its neighboring reconstructed samples from a first color component. For example, one or multiple difference values between the co-located reconstructed sample and its neighboring reconstructed samples from a first color component. The positions of the neighboring reconstructed samples are selected based on a given filter shape (e.g., as shown in FIG. 5B). The filter shape index may be signaled in a frame header.
In the second step, the derived values are quantized using a scalar quantizer. A scalar quantizer is specified by quantization intervals and quantization levels, a quantization interval is defined to be the range of values assigned to the same integer, and a quantization level is defined as the integer value to which all values within a quantization interval are assigned.
In the third step, given the quantized derived values (or quantization level) as a classifier, an offset value may be derived based on the value of given classifier. For example, the combinations of quantized values are used as indices to a selected look-up table, and the output of the selected look-up table is the offset value.

As mentioned previously, CDEF uses a non-linear low-pass filter along edge directions. CDEF includes eight predefined directional patterns, with direction detection performed in each 8×8 block. Once the direction is determined, a weighted sum of neighboring samples is calculated to reduce ringing artifacts. CDEF employs two types of non-linear filters: the primary filter and the secondary filter. The primary filter applies taps along the detected direction, while the secondary filter applies taps oriented +/−45° off the primary direction.

The edge detection method in CDEF applies 8 predefined direction patterns. The optimal direction can be determined by minimizing the sum of squared differences between the pixels at the selected locations indicated by directions, and their mean along the directions. In some conventional systems, in CCSO, only one filter shape is allowed and signaled at the frame header for edge direction. This frame level fixed edge direction lack of flexibility within the content of a frame.

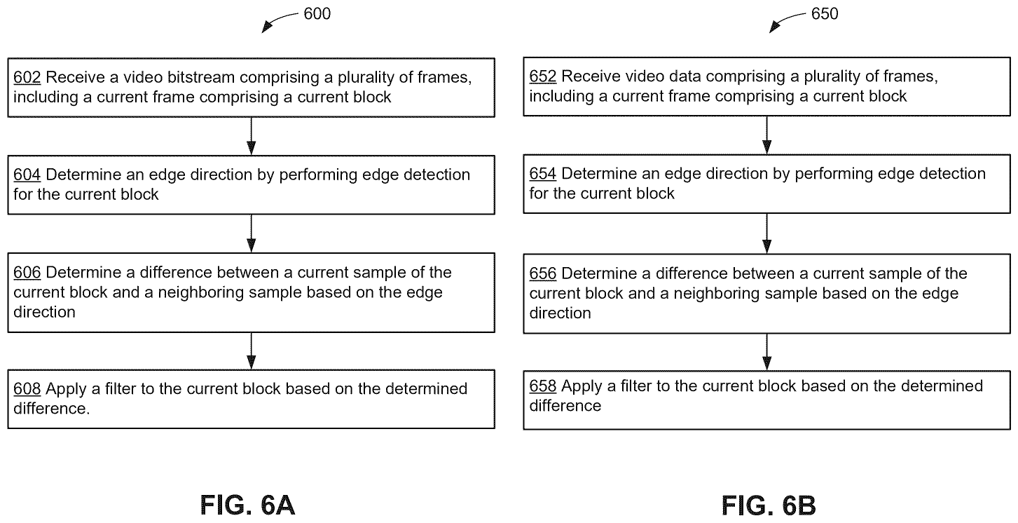

FIG. 6A is a flow diagram illustrating a method 600 of decoding video in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a video bitstream (e.g., a coded video sequence) comprising a plurality of frames (e.g., corresponding to a set of pictures), including a current frame comprising a current block. The system determines (604) an edge direction by performing edge detection for the current block. The system determines (606) a difference between a current sample of the current block and a neighboring sample based on the edge direction. The system applies (608) a filter to the current block based on the determined difference. In some embodiments, the system reconstructs the current block (e.g., applying the filter is part of the process of reconstructing the current block). In this way, an edge detection method may be used at both the encoder and decoder side to derive the edge direction (or filter index) for each block in the CCSO filtering process. The difference between the co-located (or luma) reconstructed sample and its neighboring reconstructed samples from a first color component are calculated based on this derived edge direction.

In some embodiments, the edge detection method in CDEF is directly reused to derive the filter index for CCSO. All the pixels within that 8×8 block share the same edge direction. A mapping table is designed for mapping the edge direction to the filter index. As an example, for the edge direction pattern in FIG. 5D and filter shape as shown in FIG. 5B, when the edge direction index is 5, 6, or 7, the CCSO filter index is 0; when the edge direction index is 4, then the filter index is 1; when the edge direction index is 2, the filter index is 2; when the edge direction is 0, the filter index is 3; when the edge direction index is 1 or 3, then the filter index is 4; when the edge direction index is 1, 2, or 3 and either the left and above block are also one of 1, 2, or 3, then the filter index is mapped to 5.

TABLE 1
Example edge direction mapping table for
CCSO filter shape index of FIG. 5B

| | |
|---|---|
| Edge direction index | Filter index |

| | | | |
|---|---|---|---|
| 6, 5, 7 | (90°, 112.5°, 67.5°) | 0 | (90°) |
| 4 | (135°) | 1 | (135°) |

| 2 (left and above are not 1, 2, 3) | 2 (0°, short) |
|---|---|
| (0°) | |

| | | | |
|---|---|---|---|
| 0 | (45°) | 3 | (45°) |

| 1,3 (left and above are not 1, 2, 3) | 4 (0°, middle) |
|---|---|
| (22.5°, 157.5°) | |
| 1,2,3 (either left or above are 1,2,3) | 5 (0°, long) |
| (22.5°, 0°, 157.5°) | |

As an example, for the CCSO filter shape as shown in FIG. 5C, when the edge direction index is 5, 6, or 7, then the filter index is 0; when the edge direction index is 4, then the filter index is 1; when the edge direction index is 2 and both above and left block are not direction 2, the filter index is 2; when the edge direction is 0, the filter index is 3; when the edge direction index is 2 and either left or above block is 2, then the filter index is 4; when the edge direction index is 1, then the filter index is mapped to 5; when the edge direction is index 3, then the filter index is mapped to 6.

TABLE 2
Example edge direction mapping table for
CCSO filter shape index of FIG. 5C

| | |
|---|---|
| Edge direction index | Filter index |

| | | | |
|---|---|---|---|
| 6, 5, 7 | (90°, 112.5°, 67.5°) | 0 | (90°) |
| 4 | (135°) | 1 | (135°) |

| 2 (left and above are not 2) | 2 (0°, short) |
|---|---|
| (0°) | |

| | | | |
|---|---|---|---|
| 0 | (45°) | 3 | (45°) |

| 2 (either left or above is 2) | 4 (0°, long) |
|---|---|
| (0°) | |

| | | | |
|---|---|---|---|
| 1 | (22.5°) | 5 | (22.5°) |
| 3 | (157.5°) | 6 | (157.5°) |

In some embodiments, other edge detection methods are used to derive the edge direction, e.g., the Canny edge detector, the Sobel operator, the Laplacian of Gaussian (LoG) operator, etc. Then the detected edge can be mapped to one of the filter indexes.

In some embodiments, the edge direction is determined by the edge detection method, and the difference between the collocated reconstructed samples (or luma samples) and its neighboring samples are calculated based on this detected edge.

In some embodiments, for directional intra predicted blocks, the intra prediction directions are used to derive the CCSO filter index. For other prediction mode, edge detection methods may be applied to derive the CCSO filter index. For example, for the edge direction directional intra prediction mode and filter shape as shown in FIG. 5B, when the intra prediction direction index is V_PRED, D113_PRED, or D67_PRED, then the filter index is 0; when the intra prediction direction is D135_PRED, then the filter index is 1; when the intra prediction direction is H_PRED, the filter index is 2; when the intra prediction direction is D45_PRED, the filter index is 3; when the intra prediction direction is D157_PRED or D203_PRED, then the filter index is 4; when the intra prediction direction is H_PRED, D157_PRED, or D203_PRED and either the left or above neighbor block is H_PRED, D157_PRED, or D203_PRED mode, then the filter index is mapped to 5.

TABLE 3
Example edge direction mapping table for
CCSO filter shape index of FIG. 5B

| Edge direction index | Filter index | |
|---|---|---|
| V_PRED, D113_PRED, D67_PRED | 0 | (90°) |
| D135_PRED | 1 | (135°) |
| H_PRED | 2 (0°, short) | |
| D45_PRED | 3 | (45°) |
| D157_PRED, D203_PRED | 4 (0°, middle) | |
| H_PRED, D157_PRED, | 5 (0°, long) | |
| D203_PRED when either the left or | | |
| above block is H, D157 or D203 | | |

As an example, for the edge direction directional intra prediction mode and filter shape as shown in FIG. 5C, when the intra prediction direction index is V_PRED, D113_PRED, or D67_PRED, then the filter index is 0; when the intra prediction direction is D135_PRED, then the filter index is 1; when the intra prediction direction is H_PRED, the filter index is 2; when the intra prediction direction is D45_PRED, the filter index is 3; when the intra prediction direction is H_PRED, then the filter index is mapped to 4; when the intra prediction direction is D203_PRED, then the filter index is mapped to 5; when the intra prediction direction is D157_PRED, then the filter index is mapped to 6.

TABLE 4
Example edge direction mapping table for
CCSO filter shape index of FIG. 5C

| Edge direction index | Filter index | |
|---|---|---|
| V_PRED, D113_PRED, D67_PRED | 0 | (90°) |
| D135_PRED | 1 | (135°) |
| H_PRED | 2 (0°, short) | |
| D45_PRED | 3 | (45°) |
| H_PRED | 4 (0°, long) | |
| D203_PRED | 5 | (22.5°) |
| D157_PRED | 6 | (157.5°) |

In some embodiments, the edge direction is explicitly signaled at block level, the block level can be referred as coding block level, transform block level or super-block level.

In some embodiments, the edge direction is context signaled with any the combination of plane type (luma/chroma), intra/inter mode, and neighbor block types (edge direction of left and above blocks).

In some embodiments, the unit size for CCSO/CDEF is adaptively determined for each frame. The unit for CCSO/CDEF is the minimum block size to control whether to apply CCSO or CDEF for one block.

In some embodiments, the CCSO unit size is aligned with the superblock size for current frame. For example, for intra/key frame, the superblock size is 256×256, while the inter frame have superblock size as 128×128. Then the unit size for CCSO keep the same as the frame superblock size.

In some embodiments, the unit size for both CCSO and CDEF are aligned with the superblock size. In some embodiments, within one superblock, the on/off flag for both CCSO and CDEF is shared. In some embodiments, within one superblock, the on/off flag for CCSO and CDEF is opposite. When CDEF is on/off for current superblock, the CCSO will be turned off/on. In some embodiments, multiple block partitioning types are applied to the CCSO and/or CDEF unit. The CCSO on/off controlling flag is applied to the sub-units after the block partitioning. The block partition types may be signaled into the bitstream at the high level syntax, such as sequence level, frame level, slice level, tile level, or CCSO/CDEF unit level. In some embodiments, none split, binary vertical split, binary horizontal split, and partition quad-tree split may be applied to CCSO/CDEF unit to generate sub-units.

In some embodiments, when the filter shape index is signaled at the frame level, a CCSO unit level flag is used to determine whether to turn on/off CCSO or use filter shape signaled at frame level or to use any of the preceding methods to determine filter index. For example, the syntax for this CCSO unit level flag is ccso_cdf[CDF_SIZE(3)] or ccso_cdf[plane_type][CDF_SIZE(3)]. The symbol size for this syntax is [0, 1, 2]. A parsed symbol value of “0” could mean (but not limited to) that CCSO is off for this unit, symbol value of “1” could mean (but not limited to) that signaled filter index at frame level is used for this unit and symbol value of “2” could mean (but not limited to) that filter shape is derived at unit level using any or a combination of methods described in section 1 and section 2 to determine filter index.

FIG. 6B is a flow diagram illustrating a method 650 of encoding video in accordance with some embodiments. The method 650 may be performed at a computing system (e.g., the server system 112, the source device 102, or the electronic device 120) having control circuitry and memory storing instructions for execution by the control circuitry. In some embodiments, the method 650 is performed by executing instructions stored in the memory (e.g., the memory 314) of the computing system. In some embodiments, the method 650 is performed by a same system as the method 600 described above.

The system receives (652) video data comprising a plurality of frames, including a current frame comprising a current block. The system determines (654) an edge direction by performing edge detection for the current block. The system determines (656) a difference between a current sample of the current block and a neighboring sample based on the edge direction. The system applies (658) a filter to the current block based on the determined difference. As described previously, the encoding process may mirror the decoding processes described herein (e.g., loop filtering, such as cross-component offset filtering). For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

Turning now to some example embodiments.
(A1) In one aspect, some embodiments include a method (e.g., the method 600) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames, including a current frame comprising a current block; (ii) determining an edge direction by performing edge detection for the current block; (iii) determining a difference between a current sample of the current block and a neighboring sample based on the edge direction; and (iv) applying a filter to the current block based on the determined difference. In this way, an edge detection method can be utilized at both the encoder and decoder side to derive the edge direction (or filter index) for each block in the CCSO filtering process. The difference between the co-located (or luma) reconstructed sample and its neighboring reconstructed samples from a first color component are calculated based on this derived edge direction. Therefore, the edge direction does not need to be signaled in the video bitstream. In some embodiments, the edge direction is explicitly signaled at block level (e.g., a coding block level, transform block level or super-block level) rather than a frame level. In some embodiments, the edge direction is context signaled with any the combination of plane type (luma/chroma), intra/inter mode, and neighbor block types (edge direction of left and above blocks).
(A2) In some embodiments of A1, the edge detection is performed using a constrained directional enhancement filter (CDEF) edge detection technique. For example, the edge detection method in CDEF can be directly reused to derive the filter index for CCSO. In this example, all the pixels within that 8×8 block share the same edge direction. A mapping table may be designed for mapping the edge direction to the filter index. As an example, for the edge direction pattern in FIG. 5D and filter shape as shown in FIG. 5B, when the edge direction index is 5, 6, or 7, the CCSO filter index is 0; when the edge direction index is 4, then the filter index is 1; when the edge direction index is 2, the filter index is 2; when the edge direction is 0, the filter index is 3; when the edge direction index is 1 or 3, then the filter index is 4; when the edge direction index is 1, 2, or 3 and either the left and above block are also one of 1, 2, or 3, then the filter index is mapped to 5 (e.g., as shown in Table 1).}
(A3) In some embodiments of A2, determining the edge direction comprises mapping a CDEF edge direction to a filter index. For example, for the CCSO filter shape as shown in FIG. 5C when the edge direction index is 5, 6, or 7, then the filter index is 0; when the edge direction index is 4, then the filter index is 1; when the edge direction index is 2 and both above and left block are not direction 2, the filter index is 2; when the edge direction is 0, the filter index is 3; when the edge direction index is 2 and either left or above block is 2, then the filter index is 4; when the edge direction index is 1, then the filter index is mapped to 5; when the edge direction is index 3, then the filter index is mapped to 6 (e.g., as shown in Table 2).
(A4) In some embodiments of A1, the edge detection is preformed using one or more of: a Canny edge detector, a Sobel operator, and a Laplacian of Gaussian (LoG) operator. For example, other edge detection methods can be used to derive the edge direction, e.g., the Canny edge detector, the Sobel operator, the Laplacian of Gaussian (LoG) operator, etc. Then the detected edge can be mapped to one of the filter indexes. In one embodiment, the edge direction is determined by the edge detection method, and the difference between the collocated reconstructed samples (or luma samples) and its neighboring samples are calculated based on this detected edge.
(A5) In some embodiments of A1, the edge detection is preformed using an intra prediction direction of the current block. For example, for directional intra predicted blocks, the intra prediction directions are used to derive the CCSO filter index. For other prediction mode, edge detection methods may be applied to derive the CCSO filter index.
(A6) In some embodiments of A5, the intra prediction direction is mapped to a filter index. For example, for the edge direction directional intra prediction mode and filter shape as shown in FIG. 5B when the intra prediction direction index is V_PRED, D113_PRED, or D67_PRED, then the filter index is 0; when the intra prediction direction is D135_PRED, then the filter index is 1; when the intra prediction direction is H_PRED, the filter index is 2; when the intra prediction direction is D45_PRED, the filter index is 3; when the intra prediction direction is D157_PRED or D203_PRED, then the filter index is 4; when the intra prediction direction is H_PRED, D157_PRED, or D203_PRED and either the left or above neighbor block is H_PRED, D157_PRED, or D203_PRED mode, then the filter index is mapped to 5 (e.g., as shown in [IDF Table 3]). In another example, for the edge direction directional intra prediction mode and filter shape as shown in FIG. 5C, when the intra prediction direction index is V_PRED, D113_PRED, or D67_PRED, then the filter index is 0; when the intra prediction direction is D135_PRED, then the filter index is 1; when the intra prediction direction is H_PRED, the filter index is 2; when the intra prediction direction is D45_PRED, the filter index is 3; when the intra prediction direction is H_PRED, then the filter index is mapped to 4; when the intra prediction direction is D203_PRED, then the filter index is mapped to 5; when the intra prediction direction is D157_PRED, then the filter index is mapped to 6 (e.g., as shown in Table 4).
(A7) In some embodiments of any of A1-A6, the method further comprises, for each frame in the plurality of frames, determining a respective unit size for the filter. For example, the unit size for CCSO/CDEF may be adaptively determined for each frame. The unit for CCSO/CDEF is the minimum block size to control whether to apply CCSO or CDEF for one block. In some embodiments, multiple block partitioning types may be applied to the CCSO and/or CDEF unit. The CCSO on/off controlling flag is applied to the sub-units after the block partitioning. For example, block partition types may be signaled into the bitstream at a high-level syntax, such as sequence level, frame level, slice level, tile level, or CCSO/CDEF unit level. As an example, none split, binary vertical split, binary horizontal split, and partition quad-tree split may be applied to CCSO/CDEF unit to generate sub-units.
(A8) In some embodiments of A7, the respective unit size for the current frame is determined based on a superblock size for the current frame. For example, the CCSO unit size is aligned with the superblock size for current frame. As an example, for intra/key frame, the superblock size is 256×256, while the inter frame have superblock size as 128×128. Then the unit size for CCSO keep the same as the frame superblock size.
(A9) In some embodiments of any of A1-A8, the filter comprises a cross-component sample offset (CCSO) filter. In one example, the unit size for both CCSO and CDEF are aligned with the superblock size.
(A10) In some embodiments of any of A1-A9, the filter comprises a CDEF filter. In some embodiments, within one superblock, the on/off flag for both CCSO and CDEF can be shared. In some embodiments, within one superblock, the on/off flag for CCSO and CDEF can be opposite. When CDEF is on/off for current superblock, the CCSO will be turned off/on.
(A11) In some embodiments of any of A1-A10, the method further comprises determining a filter shape for the filter by parsing an indicator from the video bitstream. For example, when the filter shape index is signaled at the frame level, a CCSO unit level flag is used to determine whether to turn on/off CCSO or use filter shape signaled at frame level or to use any of the preceding methods to determine filter index. As an example, the syntax for this CCSO unit level flag may be ccso_cdf [CDF_SIZE(3)] or ccso_cdf [plane_type] [CDF_SIZE(3)]. The symbol size for this syntax may be [0, 1, 2]. A parsed symbol value of “0” could mean (but not limited to) that CCSO is off for this unit, symbol value of “1” could mean (but not limited to) that signaled filter index at frame level is used for this unit and symbol value of “2” could mean (but not limited to) that filter shape is derived at unit level using any or a combination of methods described above to determine filter index.
(B1) In another aspect, some embodiments include a method (e.g., the method 650) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames, including a current frame comprising a current block; (ii) determining an edge direction by performing edge detection for the current block; (iii) determining a difference between a current sample of the current block and a neighboring sample based on the edge direction; and (iv) applying a filter to the current block based on the determined difference. In some embodiments, the method further includes signaling coded information for the current block. In some embodiments, the edge direction is not signaled in the video bitstream.
(B2) In some embodiments of B1, the filter comprises at least one of: a CDEF filter, and a CCSO filter. For example, the filter may be implemented as a CDEF filter alone to reduce ringing artifacts, a CCSO filter alone to adjust chroma reconstruction values based on luma edges, or a combination of both filters applied sequentially or in parallel within the in-loop filtering pipeline. In some embodiments, additional filters such as deblocking filters or loop restoration filters are included alongside CDEF and/or CCSO to further enhance video quality.
(B3) In some embodiments of B1 or B2, the edge detection is preformed using a CDEF edge detection technique. For example, the CDEF edge detection method may analyze pixel values along eight predefined directions within an 8×8 block and select the direction that minimizes the sum of squared differences. The CDEF edge detection may be modified to operate on blocks of different sizes, such as 4×4 or 16×16, depending on the coding configuration. In some embodiments, the CDEF edge detection is used not only for filtering but also for guiding other coding decisions, such as block partitioning or prediction mode selection.
(B4) In some embodiments of any of B1-B3, determining the edge direction comprises mapping a CDEF edge direction to a filter index. For example, a mapping table may be used to convert the detected CDEF edge direction index to a corresponding CCSO filter index, which then determines the filter shape and neighboring sample positions for offset calculation. In some embodiments, the mapping is context-dependent, taking into account additional factors such as the type of color plane (luma or chroma), the prediction mode, or the edge directions of neighboring blocks. In some embodiments, the mapping is dynamically updated or signaled in the bitstream to allow for greater flexibility.
(B5) In some embodiments of any of B1-B4, the edge detection is preformed using one or more of: a Canny edge detector, a Sobel operator, and an LoG operator. For example, the Canny edge detector may be used to identify strong edges within a block, and the resulting edge orientation may be mapped to a filter index for CCSO filtering. Alternatively, the Sobel operator may be applied to compute gradient magnitudes and directions, which are then used to select the appropriate filter shape. In some embodiments, a combination of edge detection methods is employed, such as applying the Sobel operator for initial edge detection and refining the result with the Laplacian of Gaussian operator. In some embodiments, custom edge detection algorithms tailored to specific video content or coding requirements are used.
(B6) In some embodiments of any of B1-B5, the edge detection is preformed using an intra prediction direction of the current block. For example, if the current block is coded using a directional intra prediction mode, the prediction direction (such as vertical, horizontal, or diagonal) may be directly used as the edge direction for filtering purposes. In some embodiments, the intra prediction direction is combined with other edge detection results to improve robustness, or used only for certain types of blocks (e.g., those with high spatial correlation). In some embodiments, the mapping from intra prediction direction to filter index is adjusted based on the coding context, such as the presence of neighboring blocks with similar prediction directions or the overall texture of the frame.
(C1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of frames, including a current frame comprising a current block; (ii) for each frame of the plurality of frames, determining a respective unit size for a filter, including determining a first unit size for current frame; and (iii) applying the filter to the current block according to the first unit size. For example, the unit size may be selected based on the type of frame, such as using a larger unit size for intra frames and a smaller unit size for inter frames. As an example, the unit size may be determined dynamically based on the resolution or content complexity of the frame. For example, the filter may be applied to blocks, tiles, slices, or other subdivisions within the frame, depending on the coding configuration. As an example, the method may include signaling the unit size in the bitstream or deriving it from other parameters
(C2) In some embodiments of C1, the first unit size for the current frame is determined based on a superblock size for the current frame. For example, the superblock size may be set to 256×256 pixels for key frames and 128×128 pixels for inter frames, and the filter unit size may be matched to these superblock sizes. As an example, the superblock size may be determined according to the video coding standard in use, such as AV1, HEVC, or VVC. As an example, the unit size may be adjusted to optimize coding efficiency for different types of video content, such as high-motion or low-motion scenes.
(D1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of frames, including a current frame comprising a current block; (ii) determining a filter shape by parsing a frame-level indicator from the video bitstream, the frame-level indicator indicating a filter shape index; and (iii) applying the filter to the current block according to the filter shape. For example, the filter shape index may be signaled in a frame header, slice header, or tile header. As an example, the filter shape may correspond to a specific spatial pattern, such as a cross, diamond, or line, which determines the arrangement of neighboring samples used for filtering. As an example, the filter shape may be overridden at a lower syntax level, such as at the block or unit level, to provide finer control over filtering operations. Multiple filter shapes may be supported and selected adaptively based on local content characteristics or coding parameters.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A11, B1-B6, C1-C2, and D1 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A11, B1-B6, C1-C2, and D1 above). In some embodiments, a memory or non-transitory computer-readable storage medium stores a video bitstream including any of the features (e.g., syntax and encoded information) disclosed herein.

The proposed methods may be used separately or combined in any order. Further, each of the methods (or embodiments), encoder, and decoder may be implemented by processing circuitry (e.g., one or more processors or one or more integrated circuits). For example, the one or more processors execute a program that is stored in a non-transitory computer-readable medium. In the following, the term block may be interpreted as a prediction block, a coding block, or a coding unit (CU).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

Although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame comprising a current block;
determining an edge direction by performing edge detection for the current block;
determining a difference between a current sample of the current block and a neighboring sample based on the edge direction; and
applying a filter to the current block based on the determined difference.

2. The method of claim 1, wherein the edge detection is performed using a constrained directional enhancement filter (CDEF) edge detection technique.

3. The method of claim 2, wherein determining the edge direction comprises mapping a CDEF edge direction to a filter index.

4. The method of claim 1, wherein the edge detection is preformed using one or more of:
a Canny edge detector, a Sobel operator, and a Laplacian of Gaussian (LoG) operator.

5. The method of claim 1, wherein the edge detection is preformed using an intra prediction direction of the current block.

6. The method of claim 5, wherein the intra prediction direction is mapped to a filter index.

7. The method of claim 1, further comprising, for each frame in the plurality of frames, determining a respective unit size for the filter.

8. The method of claim 7, wherein the respective unit size for the current frame is determined based on a superblock size for the current frame.

9. The method of claim 1, wherein the filter comprises a cross-component sample offset (CCSO) filter.

10. The method of claim 1, wherein the filter comprises a CDEF filter.

11. The method of claim 1, further comprising determining a filter shape for the filter by parsing an indicator from the video bitstream.

12. A method of video encoding performed at a computing system having memory and one or more processors, the method comprising:
receiving video data comprising a plurality of frames, including a current frame comprising a current block;
determining an edge direction by performing edge detection for the current block;
determining a difference between a current sample of the current block and a neighboring sample based on the edge direction; and
applying a filter to the current block based on the determined difference.

13. The method of claim 12, wherein the filter comprises at least one of: a CDEF filter, and a CCSO filter.

14. The method of claim 12, wherein the edge detection is preformed using a CDEF edge detection technique.

15. The method of claim 14, wherein determining the edge direction comprises mapping a CDEF edge direction to a filter index.

16. The method of claim 12, wherein the edge detection is preformed using one or more of:
a Canny edge detector, a Sobel operator, and an LoG operator.

17. The method of claim 12, wherein the edge detection is preformed using an intra prediction direction of the current block.

18. A non-transitory computer-readable storage medium storing a video bitstream that is generated by a video encoding method, the video bitstream comprising:
coded information for a plurality of blocks of video data, including a current block; and
wherein the video encoding method comprises:
determining an edge direction by performing edge detection for the current block;
determining a difference between a current sample of the current block and a neighboring sample based on the edge direction; and
applying a filter to the current block based on the determined difference.

19. The non-transitory computer-readable storage medium of claim 18, wherein the filter comprises at least one of: a CDEF filter, and a CCSO filter.

20. The non-transitory computer-readable storage medium of claim 18, wherein the edge detection is preformed using a CDEF edge detection technique.
